(19) United States
(12) Patent Application Publication
(10) Pub. No.: US 2010/0014536 A1
(43) Pub. Date: Jan. 21, 2010

(54) Method for building connection channel between network terminals through dynamic domain name sarver

(75) Inventors: Yi-Hsiang Lin, Taipei City (TW); Chi-Chou Lin, Taipei City (TW); You-Hsin Yen, Taipei City (TW)

Correspondence Address: BACON & THOMAS, PLLC, 625 SLATERS LANE, FOURTH FLOOR, ALEXANDRIA, VA, 22314-1176, US

(73) Assignee: D-Link Corporation, Taipei City (TW)

(21) Appl. No.: 12/230,264

(22) Filed: Aug. 27, 2008

(30) Foreign Application Priority Data
Jul. 17, 2008 (TW) 097127197

(51) Int. Cl. H04L 12/56

(52) U.S. Cl. 370/410

(57) ABSTRACT

A method for building a connection channel between network terminals through a dynamic domain name server (DDNS) is applied to a network system including a DDNS, the Internet, and at least one private network including more than one network address translation (NAT) router and at least one network terminal linked to the Internet through the NAT routers sequentially. The network terminal detects usable linking information of related equipments between the network terminal and the DDNS, and writes the linking information into a web page under a domain name registered with the DDNS by the network terminal, or into the DDNS. Another network terminal on the Internet wanting to link to the network terminal can input the domain name and read the linking information either from the web page or by using a utility program to search the DDNS, thereby building a connection channel with the network terminal.

### FIELD OF THE INVENTION

The present invention relates to a method for building a connection channel (i.e., tunnel) between network terminals, and more particularly to a method for building a connection channel between network terminals through a dynamic domain name server (DDNS).

### BACKGROUND OF THE INVENTION

With the rapid development of computer and telecommunication technologies, various services for carrying messages (such as voices, data, images, etc.) via a public network have become a major business of various Internet service providers (ISPs). Generally, the Internet service providers provide all kinds of comprehensive and open network services including voices, data, and multimedia through telecommunication service networks. Nowadays, methods for building telecommunication service networks are still improved, but an important development aim thereof is to separate application services from transmission technologies for the purpose of smoothly operating all of the application services on any type of transmission technologies without limitation. In other words, a future telecommunication service network will be a service-oriented network, wherein services are separate from calling controls, and calling is separate from carrying. The purpose of the foregoing separations is to allow services to be actually independent of networks, so as to flexibly and effectively provide application services. Therefore, users of the future telecommunication service network can configure and define their service characteristics by themselves without having to worry about the types of networks carrying the services and the types of terminals. The foregoing feature allows for more flexibility in providing services and applications. In other words, traditional information networks including telecommunication networks, computer networks, and cable television networks originally cannot become the only basic platform and develop services having features different from their own. However, recently, with the development of Internet protocol (IP) technologies, telecommunication networks including wire-based networks and wireless networks, computer networks, and cable television networks already can be combined into an integrated network by advanced IP technologies, i.e., a three-in-one network integration. Moreover, if mobile telecommunication networks are further added, a four-in-one network integration can be achieved. According to the Internet protocols (IP), various IP-based businesses can be realized on different networks.

Driven by the foregoing network services and under the trend of network integration, the future telecommunication service network will use a distributed network framework for effectively carrying services of voices, video, and multimedia, in order to realize a framework whose three functions of service application, service control, and service delivery are independent from one another. During network construction, the future telecommunication service network can smoothly transition from current information networks, with the advantage that current network equipments and terminals can be directly applied to the future telecommunication service network, while many IP-based protocols still can be used. However, the most important of all problems to be faced is how to traverse private networks.

The future telecommunication service network is a network integrated with voices, data, multimedia, and mobile services. A network hierarchy of the future telecommunication service network can be divided into the following layers:
(1) Access layer: it includes various gateways, intelligent access terminals, and comprehensive access equipments. The access layer allows various users to link to the network through various access means (including broadband network access and mobile network access), and converts an original information format into a new information format which can be transmitted via the network;
(2) Transport layer: It is a carrying network of the telecommunication service network, and responsible for providing a public platform for transmitting various services and media flows in groups. Presently, a main core transmission network is a broadband IP network;
(3) Control layer: It concretely carries out comprehensive control and process functions (including calling processing control, access protocol fitting, and interconnection/intercommunication) and service logics. The control layer decides the services received by users, and controls the processing of service-flow by lower-level network elements. A main body of the control layer is a softswitch equipment; and
(4) Service layer: It processes service logics, and provides comprehensive intelligent services facing users. Meanwhile, it carries out service customization and management functions of related services, such as service authorizations and service charging.

The traversal problem in broadband network access of the future telecommunication service network is a broadband network access problem of an edge access layer in the telecommunication service network. The core carrying network and the broadband network access of the future telecommunication service network are built on current IP networks, so that access users must be addressed via I-P addresses. However, the fact is, the Internet is quickly expanded and the IP addresses are seriously depleting. To solve the problem, a majority of corporate networks and local area networks deploy a network address translation (NAT) equipment at their network gateways. The NAT is an Internet standard defined under RFC 1631. The NAT is basically installed in a router and located at a border between a private network and a public network for the purpose of converting IP addresses of packets sent by network terminals in the private network. Thus, many network terminals in the private network can share the same IP address for linking to the Internet. In other words, when IP data packets sent from the private network reach the NAT equipment, the NAT converts internal IP addresses of the private network into a legal IP address of the public network. When packets sent by external devices reach the NAT equipment, the NAT can check information of a mapping table stored in the NAT to convert the IP address of the public network into an IP address of the private network for transmitting the packets to an internal receiving point. Generally, for general data packets, the NAT equipment only needs to convert IP addresses and port numbers. However, for applications of some standards such as the H.323 protocol, session initiation protocol (SIP), and media gateway control protocol (MGCP), actual media connection information is stored and transmitted in a data packet loading, which gives rise to the following problem. If a terminal A starts to call a terminal B and a softswitch transmits a calling information of the terminal A to the terminal B, the terminal B can obtain an IP address of a special network of the terminal A from a data packet loading according to the H.323 protocol and SIP protocol, and then try to build a RTP (real-time transport protocol) connection with the terminal A. However, since the IP address is private and cannot be identified in public networks, the terminal B can not build a communication connection with the terminal A. Therefore, the NAT only allows internal network terminals to build a communication connection with an external device, but does not allow other network terminals outside the network to build a communication connection with the internal network terminals in the network. As a result, while the NAT provides a protection function for network security, it also blocks communication signals from external networks (such as VoIP phone signals). Thus, the NAT protocol has become a technological barrier which prevents enterprise users from using network communication services (such as VoIP phone). Particularly, in many private networks nowadays, internal network terminals can link to the Internet and build a communication connection with external devices only through address conversion by at least two NAT equipments. As a result, many designers and manufacturers of network terminals cannot develop network terminals suitable for use in current network conditions because they cannot overcome the technological barrier of the NAT protocol in network communication services.

Therefore, it is important for many Internet service providers to figure out how to develop a network terminal which can traverse at least two NAT equipments and link to the Internet, so that another network terminal on the Internet can easily traverse the NAT equipments to build a barrier-free connection channel with the network terminal, thereby allowing the network terminals to smoothly link to and communicate with each other, or access data from each other.

In view of the aforementioned problems, the inventor of the present invention made great efforts in doing research and experiments and finally succeeded in developing a method for building a connection channel between network terminals through a dynamic domain name server (DDNS), wherein the method allows two network terminals to traverse more than one NAT equipment through a DDNS on the Internet, and build a barrier-free connection channel to link to, and access data from, each other by selectively using a universal plug-and-play Internet gateway device (UPnP IGD), a relay channel, or other means for traversing a NAT router.

### SUMMARY OF THE INVENTION

A primary object of the present invention is to provide a method for building a connection channel between network terminals through a dynamic domain name server (DDNS), which method is applied to a network system comprising a DDNS, at least one private network, and the Internet, wherein the private network includes more than one network address translation (NAT) router and at least one network terminal (such as wireless network video camera) linked to the Internet through the NAT routers. According to the method, the network terminal automatically logs in the DDNS when the network terminal is booted. After detecting usable linking information of related equipments (such as IP addresses and communication port numbers) between the network terminal and the DDNS, the network terminal writes the linking information of the related equipments into a specified web page under a domain name registered with the DDNS by the network terminal, or into an address record and a service (SRV) record of the DDNS. Therefore, when another network terminal (such as a notebook computer installed with a network card) on the Internet wants to link to the network terminal, the another network terminal can input the domain name and read the linking information of the related equipments either from the specified web page or by using a utility program to search the address record and the SRV record of the DDNS. Thus, a connection channel between the two network terminals can be built based on the linking information of the related equipments, allowing the two network terminals to link to, and access data from, each other.

A secondary object of the present invention is to provide the aforesaid method for building a connection channel between network terminals through a dynamic domain name server (DDNS), wherein when a network terminal is installed and connected to the NAT routers for the first time and booted to link to the Internet through the NAT routers, the network terminal applies for an account number from the DDNS, and registers a domain name with the account number. Thus, each time the network terminal is booted and linked to the Internet, the network terminal can automatically log in the DDNS with the account number, detect usable linking information of related equipments between the network terminal and the DDNS, and write the linking information of the related equipments into a specified web page under the domain name.

A third object of the present invention is to provide the aforesaid method for building a connection channel between network terminals through a dynamic domain name server (DDNS), so that another network terminal on the Internet can open the specified web page under the domain name through a network browser, and read the usable linking information stored in the web page of the related equipments between the network terminal and the DDNS, so as to build a connection channel with the network terminal based on the linking information of the related equipments, and transmit data to and from the network terminal.

A fourth object of the present invention is to provide the aforesaid method for building a connection channel between network terminals through a dynamic domain name server (DDNS), wherein the linking information of related equipments includes linking information of an available universal plug-and-play Internet gateway device (UPnP IGD), relay channel, or other related equipments for traversing the NAT routers, between the network terminal and the DDNS, so that the another network terminal on the Internet can build a connection channel with the network terminal based on the linking information of the related equipments by selectively using the UPnP IGD, the relay channel, or other means for traversing-the NAT routers, so as to transmit data to and from the network terminal.

### BRIEF DESCRIPTION OF THE DRAWINGS

The structure and technical means adopted by the present invention to achieve the above and other objects can be best understood by referring to the following detailed description of the preferred embodiments and the accompanying drawings, wherein

FIG. 1 is a schematic view of a network system according to the present invention;

FIG. 2 is a process flowchart of a first network terminal according to the present invention;

FIG. 3 is a process flowchart of a second network terminal according to the present invention;

FIG. 4 is a time sequence diagram of the process flowchart according to a preferred embodiment of the present invention; and

FIG. 5 is a schematic view of a window of a network browser in the second network terminal according to the preferred embodiment of the present invention.

### DETAILED DESCRIPTION OF THE PREFERRED EMBODIMENTS

A dynamic domain name server (hereinafter referred to as DDNS) is used to map a dynamic IP address of a client device to a static domain name. Each time the client device is linked to the Internet, the client device will transmit a dynamic IP address thereof to the DDNS through message transmission, so that the DDNS can provide a DNS service and carry out a dynamic domain name resolution service, for the purpose of obtaining the dynamic IP address of the client device provided by an Internet service provider (ISP) each time the client device is linked to the Internet, and then mapping the dynamic IP address used by the client device to a corresponding static domain name. Thus, regardless of the dynamic IP address with which the client device is linked to the Internet each time, other client devices on the Internet can always be linked to and communicate with the client device through the static domain name. Generally, if the client device wants to use the mechanism provided by the DDNS, the client device must firstly register a domain name with the DDNS, and download a client software, which is then install into the client device, allowing the client device to communicate with the DDNS through the client software. Therefore, each time the client device is linked to the Internet, the DDNS can determine a correspondence relationship between domain name and IP address according to the dynamic IP address used by the client device each time the client device is linked to the Internet. This operation is called “dynamic domain name resolution”, i.e., to match the static domain name registered by the client device with the dynamic IP address allocated to the client device by the ISP each time the client device is linked to the Internet. Thus, the problem that other client devices on the Internet cannot communicate with the client device due to changeable IP addresses can be solved by visiting an immobile and static domain name.

Traditionally, a DNS system establishes a rule for domain names on the Internet, wherein each domain name must correspond to a static IP address. On the other hand, a DDNS system provides a DDNS to a client device which is linked to the Internet with a dynamic IP address (such as by ADSL or dial-up), so that the DDNS can guide a domain-name search by other client devices to an IP address corresponding to the domain name. Thus, the other client devices on the Internet are allowed to link to the client device which is linked to the Internet with a dynamic IP address. However, the client device which is linked to the Internet with a dynamic IP address may be assigned a new IP address or have its IP address changed by an ISP each time the client device is linked to the Internet. Thus, the majority of organizations or suppliers providing DDNS services generally provide a client software which can detect, every few minutes, whether or not the IP address of the client device is changed, and periodically update the correspondence relationship between domain name and IP address in the DDNS. Presently, there are many commercially available IP address switches or routers which provide a DDNS setting function, so that it is possible to directly store settings of the DDNS services in the IP address switches or routers without installing a client software into the client device. Thus, the client device only needs to firstly apply for an account number from the DDNS, and register a domain name (such as yourname.tw) with the account number, so that the client device can use the registered domain name to build up a web site with dynamic IP addresses through the service of the DDNS. After the client device starts the DDNS function, the client device can automatically execute an IP renewal operation of the assigned domain name at the DDNS with the applied account number and password thereof each time the client device is booted. The DDNS will obtain the IP address of the client device when the client device is linked to the Internet, and match the IP address with the registered domain name. If the client device is booted and obtains an IP address of 211.72.210.250, the DDNS will automatically match the registered domain name (such as yourname.tw) of the client device with the IP address of 211.72.210.250. Moreover, if the client device is re-booted, obtains another IP address of 210.17.9.227, and repeats the IP renewal operation, the DDNS will match the registered domain name (such as yourname.tw) of the client device with the IP address of 210.17.9.227. Therefore, the process described above solves the problem that changeable IP addresses cannot be matched with a domain name. For other clients which want to browse the web site established by the client device, it is totally unnecessary for them to know the IP address obtained by the client device when the client device is booted. The clients only need to input the domain name (such as yourname.tw) of the client device, so as to be directly linked to the web site established by the client device.

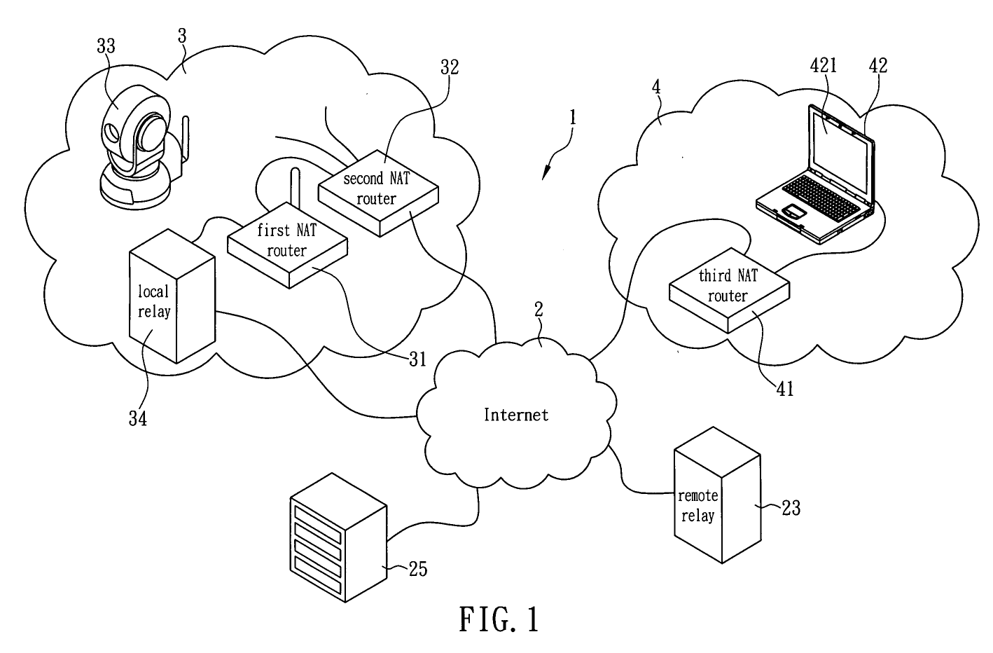

The present invention provides a method for building a connection channel between network terminals through a dynamic domain name server (DDNS) according to the operation principle of the foregoing DDNS and the “dynamic domain name resolution” technology, and the method is applied to a network system. Referring now to FIG. 1, the method is applied to a network system 1 comprising the Internet 2, a DDNS 25, and at least two private networks. In the following embodiments of the present invention, a first private network 3 and a second private network 4 are provided for illustration, wherein the first private network 3 comprises at least two network address translation (NAT) routers 31, 32 and at least one network terminal 33, while the second private network 4 comprises at least one NAT router 41 and at least one network terminal 42. In the following embodiments of the present invention, the first private network 3 comprises a first NAT router 31, a second NAT router 32, and a first network terminal 33 (such as a wireless network video camera). Meanwhile, the second private network 4 comprises a third NAT router 41 and a second network terminal 42 (such as a computer installed with a network card). However, other embodiments of the present invention are not limited to the aforesaid configuration. Each of the first private network 3 and the second private network 4 can comprise more than two network terminals and more than two NAT routers. The first network terminal 33 and the second network terminal 42 are linked to the Internet 2 through the corresponding NAT routers 31, 32, 41, respectively.

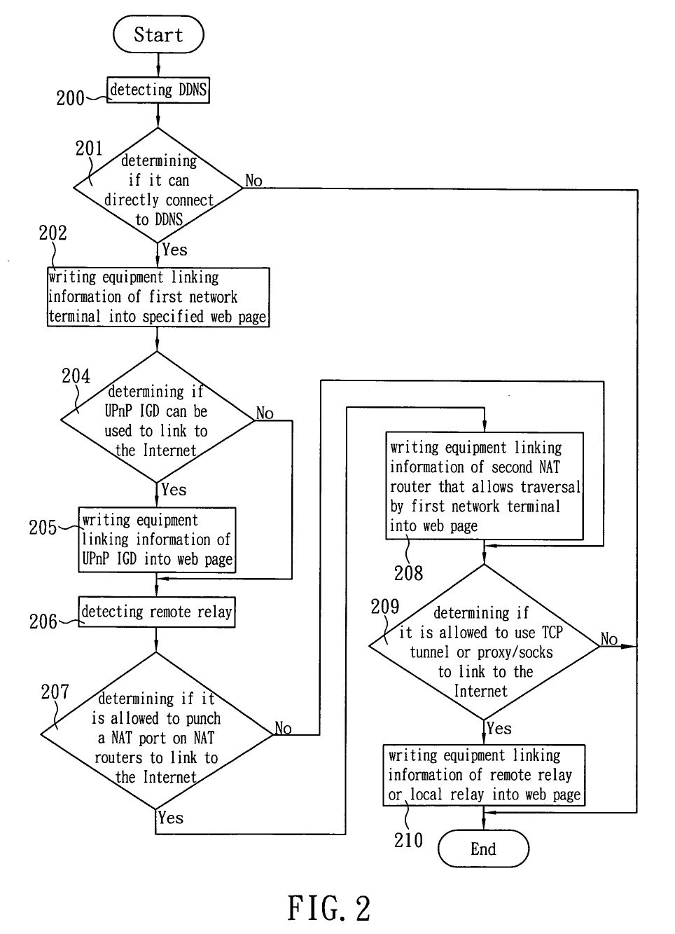

According to the method of the present invention, when the first network terminal 33 is installed and connected to the first NAT router 31 for the first time and booted to link to the Internet 2, the first network terminal 33 is linked to the Internet 2 through the first NAT router 31 and the second NAT router 32 sequentially. Then, the first network terminal 33 can apply for an account number from the DDNS 25, and register a domain name with the DDNS 25 using the account number. Thus, each time the first network terminal 33 is booted and linked to the Internet 2, the first network terminal 33 will automatically log in the DDNS 25 with the account number, and execute the following steps. Referring now to FIG. 2, the first network terminal 33 detects usable linking information of related equipments (such as IP addresses and port numbers of the related equipments) between the first network terminal 33 and the DDNS 25, and writes the linking information of the related equipments into a specified web page under the domain name, or into an address record and a service (SRV) record of the DDNS 25.

In a step 200, the first network terminal 33 sends a detection signal to detect the DDNS 25.

In a step 201, the first network terminal 33 determines whether or not it can directly connect to the DDNS 25 according to a response signal from the DDNS 25. If yes, the process goes on to the following step; if not, the process is ended.

In a step 202, the first network terminal 33 writes equipment linking information thereof (such as an IP address of 192.168.18.50) into a specified web page under the domain name.

In a step 204, the first network terminal 33 determines whether or not the first NAT router 31 can support a universal plug-and-play Internet gateway device (UPnP IGD) and allow the first network terminal 33 to use a function of port mapping. If yes, the process goes on to a step 205; if not, a step 206 is executed.

In a step 205, the first network terminal 33 performs port mapping on a TCP port of the first NAT router 31 and writes equipment linking information of the UPnP IGD (such as an IP address of 220.135.29.14 and a communication port number of 8080) into the specified web page under the domain name, wherein UPnP is a common peer-to-peer network connection structure used between computers and peripherals thereof. Particularly, UPnP is based on the Internet standard and technology, so that different equipments can automatically connect to and coordinate with each other through UPnP. In addition, under the management of a network control equipment, UPnP allows for data communication between equipments. However, the installation of NAT routers interrupts the UPnP network connection technology commonly used by family or small enterprise users. Generally, an application procedure of network connection requires the use of an address of a public network, and each communication transmission must be conducted using a single communication port number. Thus, if a private address is used on the Internet (i.e., the public network) or the same communication port number is simultaneously used, the application procedure will be stopped. In large organizations, expert information engineers are hired to maintain normal operation of company application procedures on NAT routers. However, small organizations and common users are not provided with such information management. Hence, the UPnP NAT traversal technology is developed to solve the various problems that NAT routers cause to application procedures, thereby providing an ideal solution to small organizations and common users. The UPnP NAT traversal solution is a solution established by the UPnP IGD working committee for Internet gateway devices (IGD), and comprises the following two operation modes:
(1) Manual operation: The manual operation of NAT traversal requires a user to use a network browser or a command interface tool in a computer to change certain settings of the IGD. Although a small number of users who are very familiar with network technologies can change the settings without much difficulty, it is very difficult for most users to complete the settings. Many users do not even know that the NAT traversal problem is interfering with their use of Internet services. For example, a user may want to experience a multi-user game or use other peer-to-peer services, but finds that network connection fails for some reasons. As a result, the user may try the trouble-shooting steps or make phone calls for product service, only to feel unsatisfied and have no desire to use new services or try new technologies.
(2) Automatic operation: In order not to trouble users with manually solving the NAT traversal problem, many IGD manufacturers developed software which supports the application layer, and integrated the software into the IGD. The application layer software is a specially designed application procedure. More particularly, the manufacturers encode and test specific codes so that an application procedure can automatically complete NAT traversal. If the application procedure software is updated, the application-layer codes encoded by the manufacturers must be updated and tested again. When only a few peer-to-peer or related application procedures need to be considered, it is possible and manageable for the manufacturers to solve the NAT traversal problem in a one-to-one manner. However, this approach cannot be extended to hundreds or thousands of application procedures because the development cost of such a solution may be too high, and knowledge of the principles of the respective application procedures may be required. A better solution is for the manufacturers to provide their equipments with additional software or hardware which supports UPnP, and enable other equipments and software to communicate with NAT equipments using the same technologies. Presently, only UPnP can carry out the foregoing function.

In a step 206, the first network terminal 33 sends a detection signal to a remote relay 23 for detecting traversability of the NAT routers 31, 32.

In a step 207, the first network terminal 33 determines according to a response signal from the remote relay 23 whether or not the first NAT router 31 and the second NAT router 32 allow the first network terminal 33 to punch (i.e., open) a NAT port so that the first network terminal 33 can traverse the first NAT router 31 and the second NAT router 32 sequentially and link to the Internet 2. If yes, a step 208 is execute; if not, a step 209 is executed.

In a step 208, the first network terminal 33 writes equipment linking information of the second NAT router 32 (such as an IP address of 218.210.27.64 and a communication port number of 12345) that allows traversal by the first network terminal 33 into the specified web page under the domain name.

In a step 209, the first network terminal 33 determines whether or not the first NAT router 31 and the second NAT router 32 allow the first network terminal 33 to use a TCP tunnel or a proxy/socks to link to the Internet 2. If yes, a step 210 is execute; if not, the process is ended.

In a step 210, the first network terminal 33 reads equipment linking information (such as an IP address of 140.113.102.166) of the remote relay 23 installed on the Internet 2, and writes the equipment linking information of the remote relay 23 into the specified web page under the domain name. Alternatively, the first network terminal 33 can read equipment linking information of a local relay 34 installed in the first private network 3, and write the equipment linking information of the local relay 34 into the specified web page under to the domain name. Then, the process is ended.

Therefore, the specified web page (such as http://einstein.d-life.org) under the domain name (such as http://12345678.ddns.d-life.org) in the DDNS 25 will be written with the following linking information of the related equipments:

```
Auto-Generated Web Page for
device url=“http://12345678.ddns.d-life.org”
user_sso_url =“http://einstein.d-life.org”
<html>
<head>
<title>IPCam Multiple View</title>
<meta http-equiv=″Content-Type″ content=″text/html;
charset=iso-8859-1″>
</head>
<frameset rows=″*,*″ cols=″*,*″ frameborder=″YES″ border=″1″
framespacing=″0″>
    <frame src=″http://192.168.18.50/″ name=″local″>
    <frame src=″http://220.135.29.14:8080/″ name=″upnp″>
    <frame src=″http:// 218.210.27.64:12345/″ name=″nat″>
    <frame src=″http://140.113.102.166/″ name=″tunnel″>
</frameset>
<noframes><body>
</body></noframes>
</html>
```

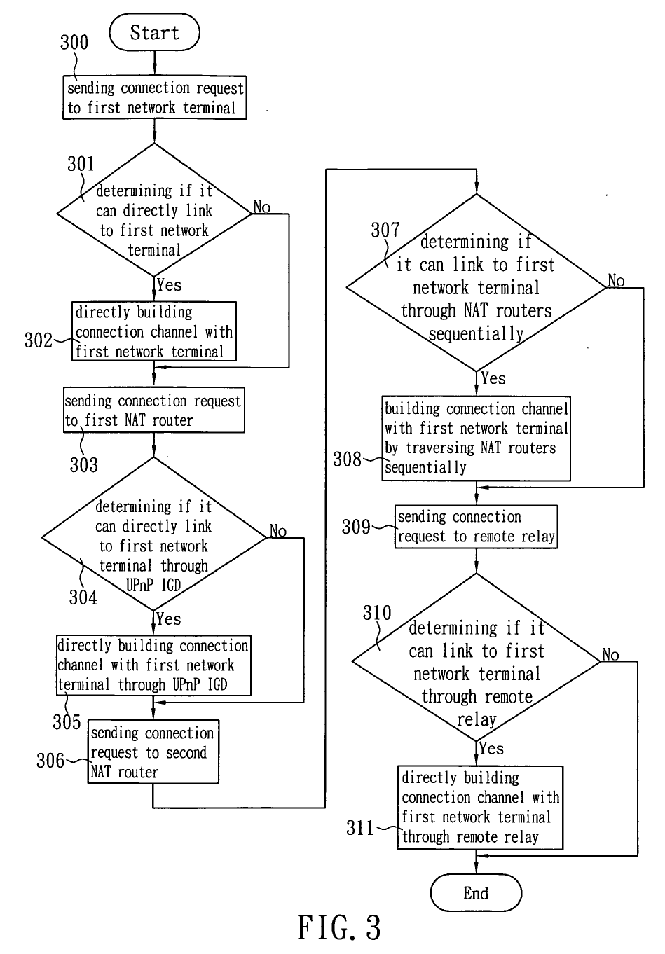

Referring back to FIG. 1, in the present invention, each time the first network terminal 33 is booted and linked to the Internet 2, and writes the usable linking information of the related equipments for linking the first network terminal 33 to the DDNS 25 into the specified web page under the domain name according to the foregoing steps, the second network terminal 42 can open the specified web page under the domain name and read the linking information of the related equipments stored in the specified web page through a network browser 421, or use a utility program to search an address record and a service (SRV) record of the DDNS 25 so as to find the linking information of the related equipments and execute the following steps. Referring now to FIG. 3, the second network terminal 42 can build a connection channel with the first network terminal 33 based on the linking information of the related equipments, and begin data transmission to and from the first network terminal 33.

In a step 300, the second network terminal 42 sends a connection request to the first network terminal 33 according to the equipment linking information of the first network terminal 33 (such as an IP address of 192.168.18.50).

In a step 301, the second network terminal 42 determines according to a response signal from the first network terminal 33 whether or not it is possible to directly link to the first network terminal 33. If yes, the process goes on to the following step; if not, a step 303 is executed.

In a step 302, the second network terminal 42 directly builds a connection channel with the first network terminal 33, and transmits data to and from the first network terminal 33.

In a step 303, the second network terminal 42 sends a connection request to the first NAT router 31 according to the equipment linking information of the UPnP IGD (such as an IP address of 220.135.29.14 and a communication port number of 8080).

In a step 304, the second network terminal 42 determines according to a response signal from the first NAT router 31 whether or not it is possible to directly link to the first network terminal 33 through the UPnP IGD. If yes, a step 305 is executed; if not, a step 306 is executes.

In a step 305, the second network terminal 42 directly builds a connection channel with the first network terminal 33 through the UPnP IGD, and transmits data to and from the first network terminal 33.

In a step 306, the second network terminal 42 sends a connection request to the second NAT router 32 according to the equipment linking information of the second NAT router 32 (such as an IP address of 218.210.27.64 and a communication port number of 12345) that allows the first network terminal 33 to open a communication port thereon.

In a step 307, the second network terminal 42 determines according to a response signal from the second NAT router 32 whether or not it is possible to link to the first network terminal 33 through the first NAT router 31 and the second NAT router 32 sequentially. If yes, the process goes on to a step 308; if not, the process goes on to a step 309.

In a step 308, the second network terminal 42 builds a connection channel with the first network terminal 33 by traversing the first NAT router 31 and the second NAT router 32 sequentially, and transmits data to and from the first network terminal 33.

In a step 309, the second network terminal 42 sends a connection request to the remote relay 23 (or the local relay 34) according to the equipment linking information of the remote relay 23 (or the local relay 34) (such as an IP address of 140.113.102.166).

In a step 310, the second network terminal 42 determines according to a response signal from the remote relay 23 (or the local relay 34) whether or not it is possible to link to the first network terminal 33 through the remote relay 23 (or the local relay 34). If yes, a step 311 is executed; if not, the process is ended.

In a step 311, the second network terminal 42 directly builds a connection channel with the first network terminal 33 through the remote relay 23 (or the local relay 34), and transmits data to and from the first network terminal 33. Then, the process is ended.

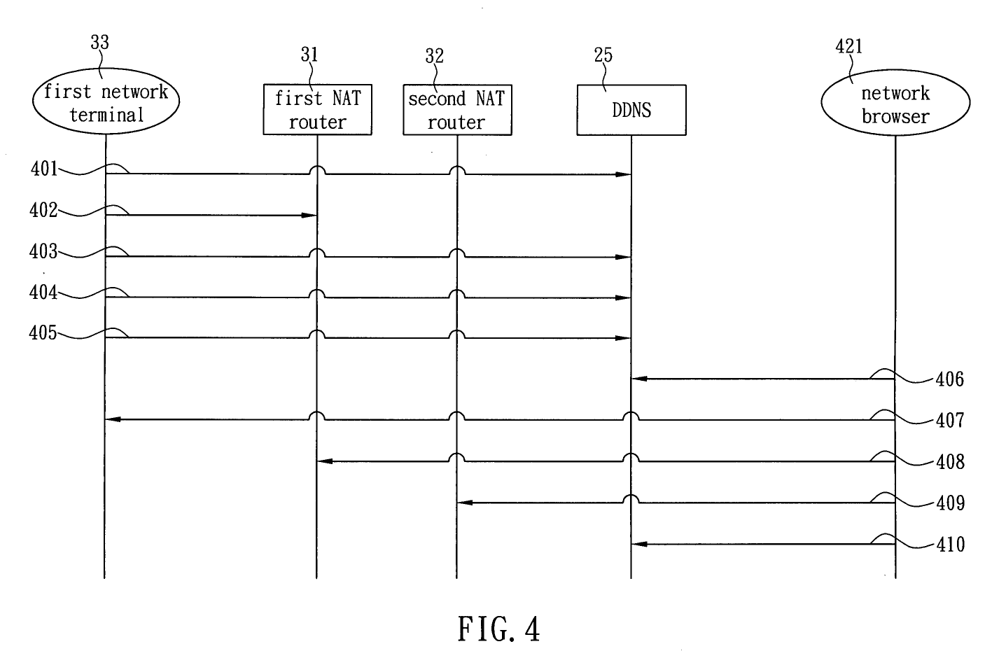

Referring back to FIG. 1, in a preferred embodiment of the present invention, the first network terminal 33 is a wireless network video camera, and the second network terminal 42 is a notebook computer installed with a network card. The first network terminal 33 is linked to the DDNS 25 installed on the Internet 2 through the first NAT router 31 and the second NAT router 32 sequentially, while the second network terminal 42 is linked to the DDNS 25 installed on the Internet 2 through the third NAT router 41. When the first network terminal 33 and the second network terminal 42 build a connection channel for transmitting data to each other according to the foregoing steps, the time sequence diagram is shown in FIG. 4 and described below in more detail:

In a step 401, when the first network terminal 33 is booted and linked to the Internet 2 through the first NAT router 31 and the second NAT router 32 sequentially and logs in the DDNS 25, the first network terminal 33 writes the equipment linking information (such as an IP address of 192.168.18.50) of the first network terminal 33 into the specified web page (such as http://einstein.d-life.org) under the domain name (such as http://12345678.ddns.d-life.org).

In a step 402, the first network terminal 33 maps a detected TCP port of the first NAT router 31 to equipment linking information (such as an IP address of 220.135.29.14 and a communication port number of 8080) of the UPnP IGD.

In a step 403, the first network terminal 33 writes the obtained equipment linking information of the UPnP IGD into the specified web page under the domain name.

In a step 404, the first network terminal 33 writes equipment linking information of the second NAT router 32 (such as an IP address of 218.210.27.64 and a communication port number of 12345) that allows the first network terminal 33 to open a communication port on the second NAT router 32 into the specified web page under the domain name.

In a step 405, the first network terminal 33 writes detected equipment linking information (such as an IP address of 140.113.102.166) of the remote relay 23 (or the local relay 34) into the specified web page under the domain name.

In a step 406, the second network terminal 42 opens the specified web page (such as http://einstein.d-life.org) under the domain name (such as http://12345678.ddns.d-life.org) through a network browser 421, and reads the usable linking information stored in the specified web page of the related equipments for linking the first network terminal 33 to the DDNS 25.

In a step 407, the second network terminal 42 directly builds a connection channel with the first network terminal 33 according to the equipment linking information (such as an IP address of 192.168.18.50) of the first network terminal 33, and transmits data to and from the first network terminal 33.

In a step 408, the second network terminal 42 directly builds a connection channel with the first network terminal 33 through the UPnP IGD according to the equipment linking information (such as an IP address of 220.135.29.14 and a communication port number of 8080) of the UPnP IGD, and transmits data to and from the first network terminal 33.

In a step 409, the second network terminal 42 builds a connection channel with the first network terminal 33 through the second NAT router 32 and the first NAT router 31 sequentially according to the equipment linking information (such as an IP address of 218.210.27.64 and a communication port number of 12345) of the second NAT router 32 that allows traversal by the first network terminal 33, and transmits data to and from-the first network terminal 33.

In a step 410, the second network terminal 42 directly builds a connection channel with the first network terminal 33 through the remote relay 23 (or the local relay 34) according to the equipment linking information (such as an IP address of 140.113.102.166) of the remote relay 23 (or the local relay 34), and transmits data to and from the first network terminal 33.

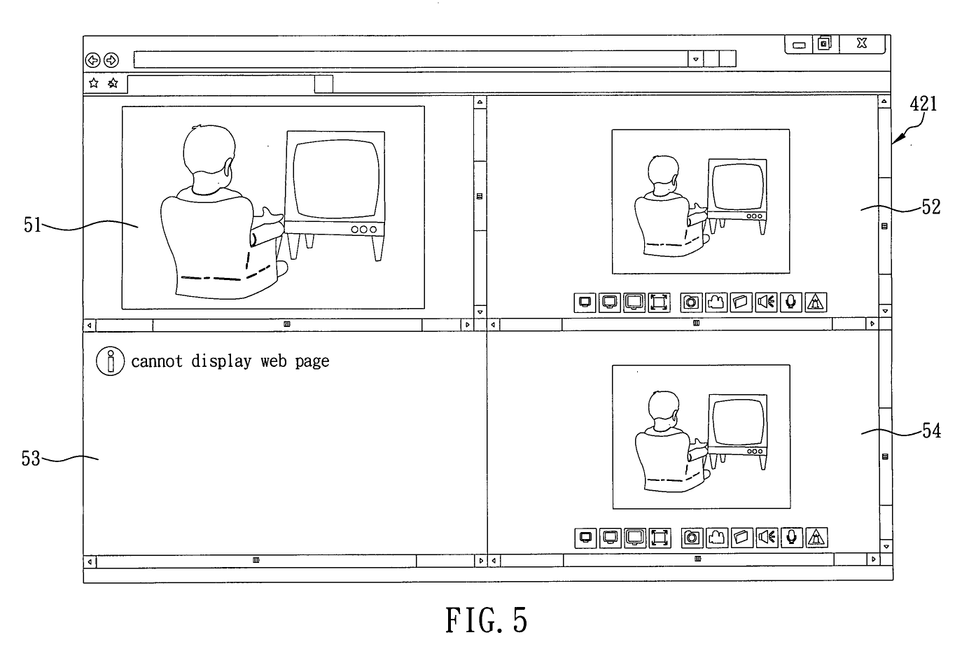

Therefore, referring now to FIG. 5, in actual operation, the network browser 421 installed on the second network terminal 42 can read from the DDNS 25 the linking information of related equipments stored in the specified web page (such as http://einstein.d-life.org) under the domain name (such as http://12345678.ddns.d-life.org), and use the linking information of the related equipments to build four connection channels with the first network terminal 33, in order to receive digital images captured by the first network terminal 33 and display the digital images in different sub-windows 51, 52, 53 and 54 of the network browser 421 of the second network terminal 42, respectively. Since the second NAT router 32 is installed with an enterprise firewall which does not allow the first network terminal 33 to open a communication port on the second NAT router 32, the first network terminal 33 cannot traverse the second NAT router 32 and the first NAT router 31 sequentially to build a connection channel for transmitting the digital images. As a result, the sub-window 53 cannot display the digital images captured by the first network terminal 33, while the remaining three sub-windows 51, 52 and 54 can link directly to the first network terminal 33, or indirectly through one of the UPnP IGD and the remote relay 23 (or the local relay 34) for building a connection channel and receiving the digital images captured by the first network terminal 33.

The present invention has been described with a preferred embodiment thereof and it is understood that many changes and modifications to the described embodiment can be carried out without departing from the scope and the spirit of the invention that is defined only by the appended claims.

What is claimed is:

1. A method for building a connection channel between network terminals through a dynamic domain name server (DDNS), applied to a network system comprising a DDNS, at least one private network and the Internet, wherein the private network includes more than one network address translation (NAT) router and at least one network terminal linked to the Internet through the NAT routers sequentially, the method comprising the network terminal, when booted, executing steps of:
logging in the DDNS;
detecting usable linking information of related equipments between the network terminal and the DDNS; and
writing the linking information of the related equipments into a specified web page under a domain name registered with the DDNS by the network terminal, after the linking information of the related equipments is detected.

2. The method of claim 1, wherein when the network terminal is installed and connected to the NAT routers for a first time and linked to the Internet through the NAT routers sequentially, the network terminal executes steps of:
applying for an account number from the DDNS; and
registering the domain name with the account number, and building the web page under the domain name.

3. The method of claim 2, wherein when another network terminal on the Internet is going to link to the network terminal, the another network terminal executes steps of:
inputting the domain name;
logging in the DDNS;
reading the linking information of the related equipments from the web page under the domain name; and
building a connection channel between the two network terminals based on the linking information of the related equipments.

4. The method of claim 3, wherein the linking information of the related equipments comprises an IP address of the network terminal.

5. The method of claim 3, wherein the linking information of the related equipments comprises an IP address and a port number of the network terminal.

6. The method of claim 3, wherein the linking information of the related equipments further comprises an IP address of a remote relay installed on the Internet.

7. The method of claim 3, wherein the linking information of the related equipments further comprises an IP address of a local relay installed on the private network, in which the local relay is connected to the NAT routers and the Internet, respectively.

8. The method of claim 3, wherein the linking information of the related equipments further comprises an IP address and a port number of a universal plug-and-play Internet gateway device (UPnP IGD) mapped by the NAT routers.

9. The method of claim 3, wherein the linking information of the related equipments further comprises an IP address and a port number of the NAT routers that allow traversal by the network terminal.

10. The method of claim 4, wherein the another network terminal uses a network browser to open the web page under the domain name.

11. The method of claim 5, wherein the another network terminal uses a network browser to open the web page under the domain name.

12. The method of claim 6, wherein the another network terminal uses a network browser to open the web page under the domain name.

13. The method of claim 7, wherein the another network terminal uses a network browser to open the web page under the domain name.

14. The method of claim 8, wherein the another network terminal uses a network browser to open the web page under the domain name.

15. The method of claim 9, wherein the another network terminal uses a network browser to open the web page under the domain name.

16. The method of claim 10, further comprising the network terminal automatically logging in the DDNS with the account number each time the network terminal is booted and linked to the Internet.

17. The method of claim 11, further comprising the network terminal automatically logging in the DDNS with the account number each time the network terminal is booted and linked to the Internet.

18. The method of claim 12, further comprising the network terminal automatically logging in the DDNS with the account number each time the network terminal is booted and linked to the Internet.

19. The method of claim 13, further comprising the network terminal automatically logging in the DDNS with the account number each time the network terminal is booted and linked to the Internet.

20. The method of claim 14, further comprising the network terminal automatically logging in the DDNS with the account number each time the network terminal is booted and linked to the Internet.

21. The method of claim 15, further comprising the network terminal automatically logging in the DDNS with the account number each time the network terminal is booted and linked to the Internet.

22. A method for building a connection channel between network terminals through a dynamic domain name server (DDNS), applied to a network system comprising a DDNS, at least one private network and the Internet, wherein the private network includes more than one network address translation (NAT) router and at least one network terminal linked to the Internet through the NAT routers sequentially, the method comprising the network terminal, when booted, executing steps of:
logging in the DDNS;
detecting usable linking information of related equipments between the network terminal and the DDNS; and
writing the linking information of the related equipments into an address record and a service (SRV) record of the DDNS respectively, after the linking information of the related equipments is detected.

23. The method of claim 22, wherein when the network terminal is installed and connected to the NAT routers for a first time and linked to the Internet through the NAT routers sequentially, the network terminal executes steps of:
applying for an account number from the DDNS; and
registering a domain name with the account number, and building a web page under the domain name.

24. The method of claim 23, wherein when another network terminal on the Internet is going to link to the network terminal, the another network terminal executes steps of:
inputting the domain name;
logging in the DDNS;
reading the linking information of the related equipments from the address record and the service (SRV) record of the DDNS; and
building a connection channel between the two network terminals based on the linking information of the related equipments.

25. The method of claim 24, wherein the linking information of the related equipments comprises an IP address of the network terminal, in which the IP address is written into the address record of the DDNS.

26. The method of claim 24, wherein the linking information of the related equipments comprises an IP address and a port number of the network terminal, in which the IP address and the port number are written into the address record and the service (SRV) record of the DDNS, respectively.

27. The method of claim 24, wherein the linking information of the related equipments further comprises an IP address of a remote relay installed on the Internet, in which the IP address is written into the address record of the DDNS.

28. The method of claim 24, wherein the linking information of the related equipments further comprises an IP address of a local relay installed on the private network, in which the IP address is written into the address record of the DDNS, and the local relay is connected to the NAT routers and the Internet, respectively.

29. The method of claim 24, wherein the linking information of the related equipments further comprises an IP address and a port number of a universal plug-and-play Internet gateway device (UPnP IGD) mapped by the NAT routers, in which the IP address and the port number are written into the address record and the service (SRV) record of the DDNS, respectively.

30. The method of claim 24, wherein the linking information of the related equipments further comprises an IP address and a port number of the NAT routers that allow traversal by the network terminal, in which the IP address and the port number are written into the address record and the service (SRV) record of the DDNS, respectively.

31. The method of claim 25, wherein the another network terminal uses a utility program to search the address record and the SRV record of the DDNS for finding the linking information of the related equipments.

32. The method of claim 26, wherein the another network terminal uses a utility program to search the address record and the SRV record of the DDNS for finding the linking information of the related equipments.

33. The method of claim 27, wherein the another network terminal uses a utility program to search the address record and the SRV record of the DDNS for finding the linking information of the related equipments.

34. The method of claim 28, wherein the another network terminal uses a utility program to search the address record and the SRV record of the DDNS for finding the linking information of the related equipments.

35. The method of claim 29, wherein the another network terminal uses a utility program to search the address record and the SRV record of the DDNS for finding the linking information of the related equipments.

36. The method of claim 30, wherein the another network terminal uses a utility program to search the address record and the SRV record of the DDNS for finding the linking information of the related equipments.

37. The method of claim 31, further comprising the network terminal automatically logging in the DDNS with the account number each time the network terminal is booted and linked to the Internet.

38. The method of claim 32, further comprising the network terminal automatically logging in the DDNS with the account number each time the network terminal is booted and linked to the Internet.

39. The method of claim 33, further comprising the network terminal automatically logging in the DDNS with the account number each time the network terminal is booted and linked to the Internet.

40. The method of claim 34, further comprising the network terminal automatically logging in the DDNS with the account number each time the network terminal is booted and linked to the Internet.

41. The method of claim 35, further comprising the network terminal automatically logging in the DDNS with the account number each time the network terminal is booted and linked to the Internet.

42. The method of claim 36, further comprising the network terminal automatically logging in the DDNS with the account number each time the network terminal is booted and linked to the Internet.
